(19) United States
(12) Patent Application Publication
(10) Pub. No.: US 2007/0124437 A1
(43) Pub. Date: May 31, 2007

(54) Method and system for real-time collection of log data from distributed network components

(75) Inventor: Steven Chervets, Longmont, CO (US)

Correspondence Address: SCHWEGMAN, LUNDBERG, WOESSNER & KLUTH, P.A., P.O. BOX 2938, MINNEAPOLIS, MN, 55402, US

(73) Assignee: Cisco Technology, Inc.

(21) Appl. No.: 11/290,350

(22) Filed: Nov. 30, 2005

(51) Int. Cl. G06F 15/173

(52) U.S. Cl. 709/223

(57) ABSTRACT

Methods and systems for collecting log data from one or more components distributed in a network are described. In one example, a method may include providing a server with a persistent storage device such as a disk drive and the server may be in communication with the one or more components in the network. Log data may be collected at the components and an error from a first component may be reported to the server. In response thereto, log data related to the error may be requested from other components and communicated to the server. The components may each maintain log data locally and either report the occurrence of errors that occur at the component or component's node, or respond to requests from the server for data related to errors or events that occurred at other nodes. Accordingly, the server may maintain a real-time collection of error log data.

### TECHNICAL FIELD

This application relates, in general, to data processing techniques, and more specifically to collecting log data from components or nodes in a network.

### BACKGROUND

With components or software products that are distributed throughout a network such as the Internet or other networks, each component may be responsible for maintaining a log of events. These logs may contain a sequence of events or relate to a transaction, and the log can be used to troubleshoot a networked system when errors occur in the network or at the individual components. The components may be arranged in nodes in the network, and each node may have one or more components. Examples of such distributed network components include voice over IP telephone systems wherein each node may comprise a call control node having numerous IP phones; distributed web applications, distributed database systems, and CRM systems.

Conventionally in distributed systems, each node collects its own logs of data. FIG. 1 illustrates an example of a distributed logging system 10 wherein each node 12A, B, C, D in the logging system 10 collects its own logs 14A, B, C, and D of data. The logs of data may include error logs, states of the node or of the system, or other data of interest. For instance, when errors occur at a first node 12A, the log 14A maintained at the first node 12A can be utilized to analyze the sequence of events which occurred prior to the occurrence of the error at that node. Because of the distributed nature of the system of FIG. 1, many of the nodes maintain their own logs independent of one another. One benefit of this system is the fact that each node collects its own log so that the data collection process is localized at each node.

However, as recognized by the present inventor, the system of FIG. 1 makes it difficult to analyze and correlate the data, from a system prospective, between the nodes. In other words, if an event of interest took place at a first node and a system administrator or other analyst wishes to analyze the state of a second, third or other node with regard to the event of interest, correlating the data from the logs of the different nodes can be extremely complicated and time consuming.

### BRIEF DESCRIPTION OF THE DRAWINGS

FIG. 1 illustrates an example of a block diagram of a conventional system for logging data.

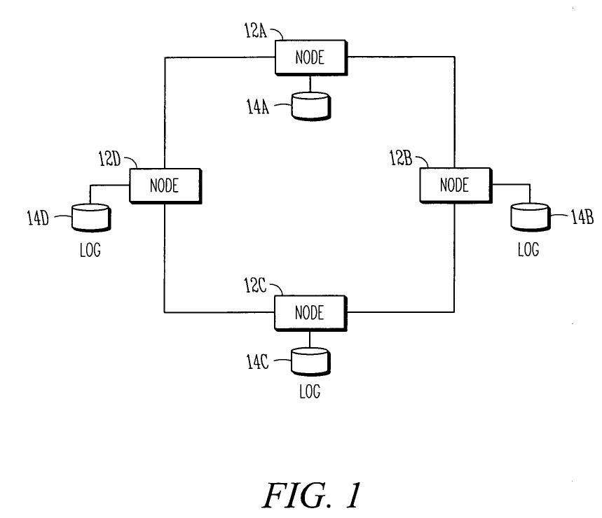

FIG. 2 illustrates an example of a block diagram of a system for selectively collecting data, in real time, at a server from various components over a network, in accordance with one embodiment.

FIG. 3 illustrates an example of operations for selectively collecting data, in real time, at a server from various components over a network, in accordance with one embodiment.

FIG. 4 illustrates an example of operations for a component to report error data, in real time, to a server, in accordance with one embodiment of the present invention.

FIG. 5 illustrates a diagrammatic representation of machine in the exemplary form of a computer system within which a set of instructions, for causing the machine to perform any one or more of the methodologies discussed herein, may be executed.

### DETAILED DESCRIPTION

Embodiments of the present application automate many of the tasks involved in manually collecting logs. In general and according to one embodiment, distributed components in a network may use or include a logging client or client module to make a connection to a logging server. If any component in the network detects an error condition and marks a set of logs as related to the error, the logging client will send the logs related to the error to the logging server. In addition, the logging client may send one or more event keys (identifiers related to the transaction or error) to the logging server. The logging server may use these keys to query the other distributed components for error information related to the one or more keys (e.g., related to the original error), and the other components report portions of their respective logs that relate to the one or more event keys. In this way, the logging server can collect and aggregate, in real-time, relevant information from the distributed components relating to any errors or transactions that occur throughout or within the network. The data stored by the server is then available for future access by support personnel (e.g., system administrators). The logging server can also take any action needed to report the error to a third party, if desired, depending upon the implementation.

The terms “logging client”, “log client”, and “client module” are used interchangeably and include a portion of a component or node that is responsible for or has access to a logging function. Depending upon the implementation, a logging client may include one or more of the functions and operations disclosed herein. The terms “logging server” and “log server” are used interchangeably herein and include a portion of a server that is responsible for collecting or has access to log data from the logging clients.

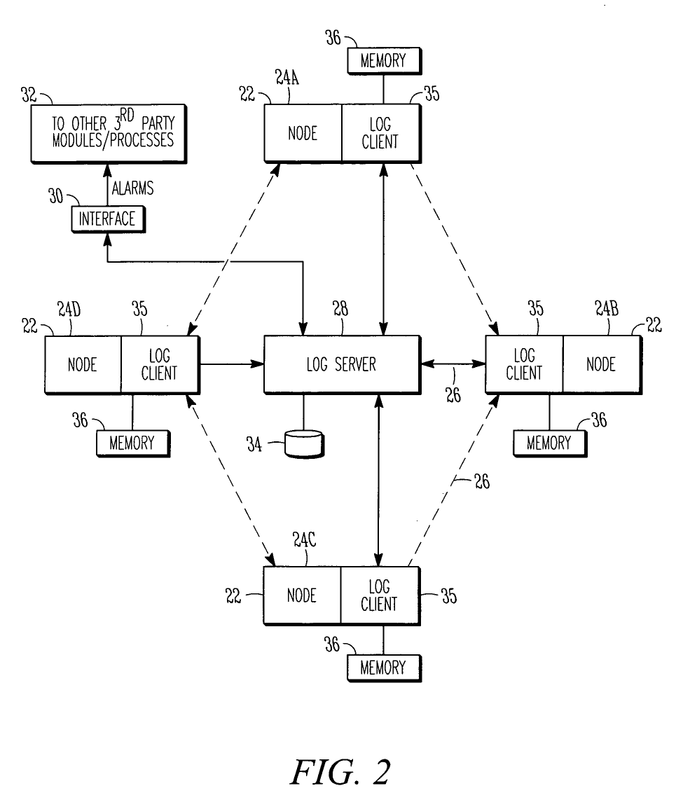

FIG. 2 illustrates an example of a block diagram of a system 20 for real-time collection of log data from distributed network components 22, according to one embodiment. Distributed network components 22 are represented in FIG. 2 as nodes 24A, B, C, and D and may include a variety of components that are connected to one or more networks 26. Examples of distributed network components 22 include, but are not limited to, computing devices, networked peripherals, Voice-over-IP telephone nodes, call processing nodes, web servers, distributed databases, distributed software application, and the like.

In the example system 20 of FIG. 2, a log server 28 is provided and is in communication with each distributed network component or node 22 over a wired or wireless network 26. It will be appreciated that any number of nodes may be provided.

The log server 28 is responsible for requesting and collecting logs from each of the nodes 24A-D that the log server 28 is in communications with. The log server 28 may be provided with interface(s) 30 so that it may communicate with other management modules or components 32 to which the log server 28 can report data of interest. The interface 30, in one example, is an SNMP interface so that the log server 28 can generate alarms and provide access to the collected logs. For example, if errors tracked by the log server 28 exceed a particular threshold or are of a particular type of critical or important error, the log server 28 may report this information to the other modules/components 32 as desired depending upon the particular implementation. In one example, the log server 28 pushes data to the other modules/components 32, and in another example the log server 28 makes data available through the interface 30 to the other modules/components 32 which may periodically poll the log server 28.

In one example, the log server 28 maintains one or more persistent memory devices 34 for storing the log data that it receives from the various nodes 24A-D. For example, the persistent memory 34 may include conventional storage devices such as one or more disk drives or other memory devices, and conventional techniques for data correction, mirroring, compressions or other data storage techniques may be utilized.

Each distributed network component 22 or node 24A-D in the system 20 of FIG. 2 may connect with the log server 28 through a logging client 35, which may be a process implemented by a network component 22 at a node 24A-D. In one example, the logging client 35 can be in the form of a static library, dynamic link library, or stand alone application or other computer process. Each distributed network component 22 or node 24A-D may be provided with a memory 36, which may be integrated within the distributed network component, and can include memories such as volatile cache, non-volatile cache, hard drives, static memories, or any conventional memory. If desired, a log client 35 may compress log data locally within memory 36 in order to reduce the amount of memory required to store log data.

Generally, the logging client 35 of a node 24A-D makes a network connection to the log server 28, for example, by registering with the log server 28, and then each logging client 35 of a node 24A-D collects log data of interest in memory 36, on disk or both. As the log data is collected by the logging client 35 at the particular distributed network component 22 or node 24A-D, the logging client 35 can index the log data so that searching of the logs can be performed later. The logging client 35 of a node 24A-D may, in one example, maintain a set of identifiers or keys related transactions or operations performed at the device or network component 22/node 24. When an error occurs at the distributed network component or node 22, the associated logging client 35 of the respective network component 22 or node 24A-D reports the error to the log server 28 for collection therein.

Other features that may be included or operations that can be performed by the log server and log client are described herein.

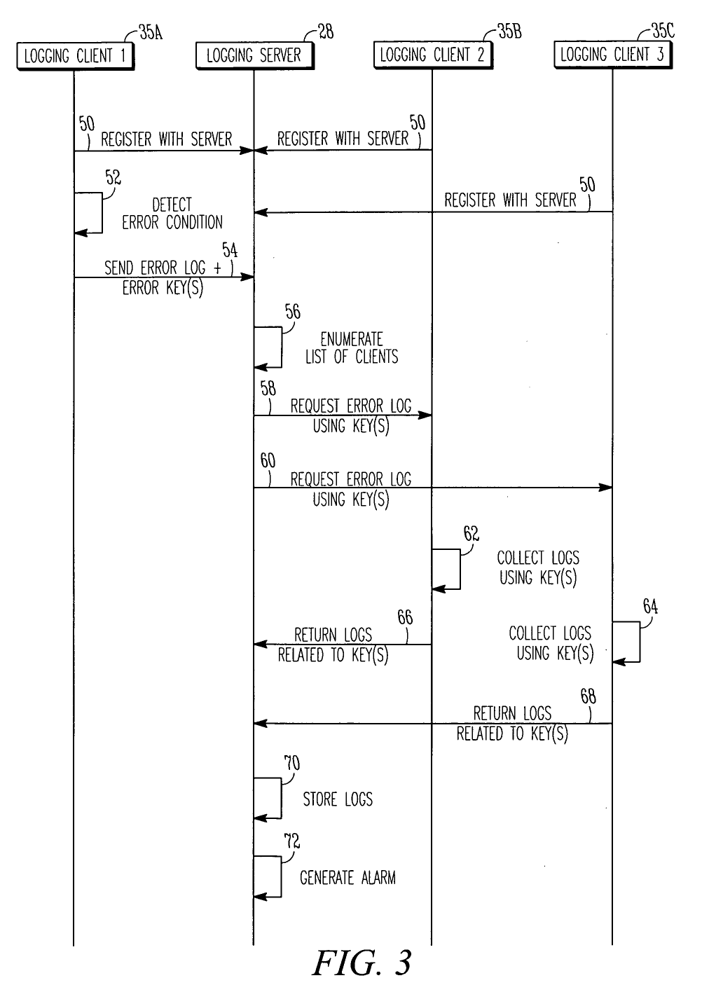

FIG. 3 illustrates an example of a process flow diagram for a plurality of log clients 35A, B, C (shown as logging clients 1, 2, and 3) and a logging server 28, in accordance with one embodiment. It is understood that FIG. 3 is provided as an example, and that other embodiments may utilize fewer or more operations or different sequences of operations depending upon the implementation.

At operation 50, logging client 1 (35A) and logging client 2 (35B) register with the logging server 28. Logging client 3 (35C) is shown registering with server 28 at operation 50 as well, although the registration of each logging client 35A-C with the logging server 28 may occur at different times. At operation 52, logging client 1 (35A) detects an error condition locally within its distributed network component or its node. At operation 52, the logging client 1 (35A) collects all logs related to the error condition, transaction or event.

At operation 54, the logging client 1 (35A) sends an error log to the logging server 28. The logging client 1 (35A) may also, if desired, send error or event keys along with the log of data at operation 54. The logging client 1 (35A) sends a set of identifiers or keys to the server 28 that can be used to help other nodes 35B, 35C identify data related to the errors. For instance, in a Voice-over-IP distributed telephony system, this identifier or event key may be a call identifier, phone number, device identifications, or any other unique identifier.

At operations 56-60, the logging server 28 generates a list of logging clients and asks the logging clients 35A-C if they have any data related to the error or event key reported by logging client 1 (35A). The error or event keys sent by logging client 1 (35A) will be used by the other logging clients 35B, 35C to find any log information in their respective logs related to the error or event key.

Upon receiving the error log sent by logging client 1 (35A), at operation 56 the logging server 28 may enumerate the list of clients in communications with the logging server. In this case, 28 has received registrations from logging clients 1, 2, and 3 (35A-C). In one example, because the logging server 28 received an error log from logging client 1 (35A), the logging server 28 may generate requests for log data from the other clients 35B, 35C so that logging server 28 has a complete set of log data, related to the event key, from all clients 35A-C in the system of this example.

In one example, at operation 58 the logging server 28 requests log data from logging client 2 (35B), and the request may specify the error or event keys which the logging server 28 is interested in receiving data. Similarly, at operation 60 the logging server 28 may request log data using the error or event keys, and this request may be sent to logging client 3 (35C). At this point, logging clients 2-3 (35B, 35C) will check their respective logs to see if they have any data relating to the error or event key.

In response, the logging client 2 (35B) collects its logs, at operation 62, using the error or event keys specified by the logging server 28 at operation 58. At operation 62, the log search by the logging client 2 (35B) may be done in memory or on disk, depending on how the particular logging client is configured. The logging client 3 (35C) collects relevant log data at operation 64 using the error or event keys specified by logging server 28 at operation 60.

Once the logging clients 35B, 35C locate logs related to the error or event keys, at operations 66-68 the logs are sent back to the logging server 28 which then stores them, on disk in one example, at operation 70. At operation 66, the logging client 2 (35B) returns the log data related to the error or event keys specified by the logging server 28, and at operation 68 the logging client 3 (35C) returns the log data related to the error or event keys specified by the logging server 28 at operation 60.

At operation 70, upon receiving one or more data logs, the logging server 28 stores the one or more data logs. At this point, all data logs related to the error or event keys may have been collected and stored at a central location associated with the server 28. Even if the administrator is unable to examine the logs stored at the server 28 over several days (and the logs at the logging clients have been overwritten with new data), the relevant log data will still be stored at the logging server 28. This feature may be particularly useful in systems with a large number of transactions, such as telephony or banking systems for example.

If necessary, based upon the implementation and the nature of the errors received by the logging server 28 at operation 70, the logging server 28 may generate alarms at operation 72 that are transmitted to other modules or components that are interested in receiving such alarms. In one example, the logging server 28 will generate an SNMP alarm or other alarms via its third party interface to inform the administrator or other support personal that an error condition has been detected. The type of alarm transmitted is a matter of choice depending on the particular implementation.

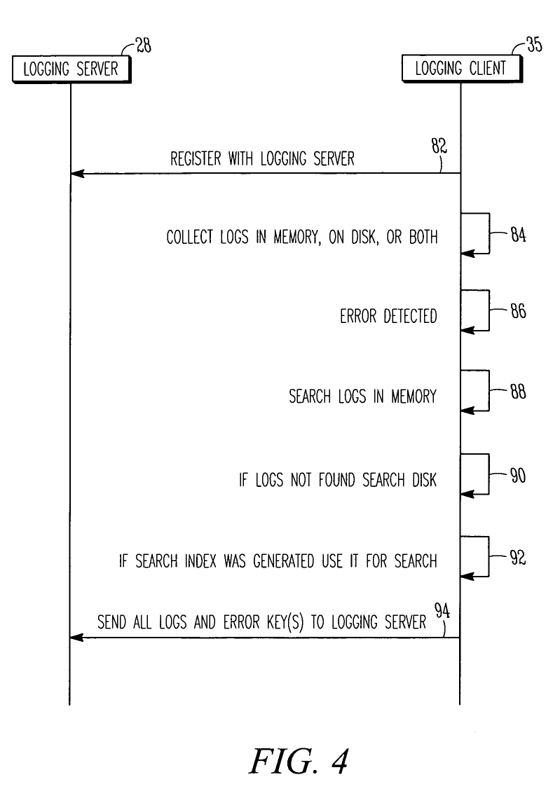

FIG. 4 illustrates an example of operations that a logging client 35 may implement in accordance with one embodiment. It should be understood that FIG. 4 is provided as an example, and that other embodiments may utilize fewer or more operations or different sequences of operations depending upon the implementation.

At operation 82, a logging client 35 (e.g., a logging client 35A-C) may register with a logging server 28 (e.g., the logging server 28) in order to make the logging server 28 aware of the presence of the logging client 35 in the system. At operation 84, the logging client 35 collects logs in memory. The logging client 35 may store these logs on disk or in memory, or both, if desired, and, as explained above, may compress the data locally. Further, in another example, the logging client 35 may index the data as it is stored in memory and/or on disk. The index may include associating event keys or transaction codes with the log data entries.

In one example, the logging client 35 can be configured to store logs in memory and not on disk. This example may be particularly well suited for systems with short lived discrete transactions. These transactions can be kept in memory for a short period of time and then discarded. If an error is detected on any node, in one embodiment all nodes may be queried so the in-memory transactions should be maintained long enough to allow queries from other nodes to be completed. For example, if a transaction lasts 1 minute, then in one example the transaction may be kept in memory for approximately another 5 minutes before it is replaced with another transaction.

If the log data is stored on disk, then the logging client 35 can generate a string search index to allow fast log searching. Alternatively, a hybrid approach can be used where the most recent logs can be stored in memory and then flushed to disk a short time later. Using this approach, it is likely that any logs related to a recent error on a different node will still be in memory so that logs can be collected and sent to the logging server 28 without resorting to accessing the hard disk. However, if the logs are not available in memory, then it is still possible to access older logs on disk, for instance by possibly using a search index.

In one example, each node/logging client 35 maintains a rolling log, wherein the log may be configured as a circular buffer, FIFO buffer or similar structure wherein memory is allocated, statically or dynamically, for the purpose of maintaining log data. By collecting related logs from all nodes at once, the chance of losing data because logs have rolled or memory is full may be reduced.

Furthermore, in one example, it is possible to configure the logging client 35 to store all of its logs in memory, using different levels of cache and disk storage techniques, and/or by using conventional data compression/decompression. While this approach uses more memory than a buffer approach, this approach can be fast. Since any errors are collected in real time from all logging clients and stored on disk by the logging server 28, it is unlikely that data will be lost.

In an example embodiment, selected error conditions are identified and error keys are created and associated with each selected error condition. This may facilitate the reporting of log data by the logging clients 35 upon the occurrence of an error at one of the logging clients. If an unknown error condition can arise, then storing logs on a disk locally at each node may be beneficial so to reduce the chance that the local log memory has been overwritten with newer log data before the error has been identified.

At operation 86, an error is detected at the logging client 35. The error may include, for example, an error that occurs within the distributed network component of the node, or if multiple components are coupled with the node or with the distributed network component, the error may include an error that occurs within the subsystem coupled with the node.

At operation 88, the logging client 35 searches the logs in memory. For example, if the logs are maintained in a cache memory, and if no logs are found in the cache memory, then at operation 90, the logging client 35 may search for logs stored on disk if the storage policy at the logging client 35 was to store logs on disk.

If a search index was generated as the logs were collected at operation 84, then the search index may be utilized at operation 92 in order to search for data of interest relating to the error detected at operation 86. At operation 94, all logs that are related to the error or event keys are shown to be transmitted from the logging client 35 to the logging server 28.

In an example embodiment, when the logging clients 35 are queried for information related to an error or event key, the logging clients 35 may send back any related information related to the error or event keys, including other event keys associated with that information. This can be used to create a history of an error event that may have moved around between network nodes. For example, in an IP telephony system, if a customer was transferred five times it is possible that logs related to that customer are stored on 3 different nodes. The customer's ANI (automatic number identification) may have been lost on the third transfer, which means the logs for the original call may not be retrieved. However, if each node sends back keys related to the logs they found, it may be possible to retrieve additional logs (and thus the original customer call). In order to reduce the amount of data retrieved in this embodiment, in one example the original logs and logs for one more set of event keys are retrieved. In this way, a logging server will send, in one example, two or less system wide queries related to a single error.

It can be seen that the example embodiments described herein may be configured to transmit data of relevant data logs from a logging client over the network to a logging server when errors have been detected, as opposed to continuously transmitting all data logged by all logging clients. Hence, when compared with such continuously transmitting systems, a logging server of an embodiment of the present application may store log data related to specific error or event keys and selectively use the network when errors have been detected, thereby using less disk storage at the logging server and less network bandwidth.

Example embodiments can be embodied in a computer program product. It will be understood that a computer program product including features of the present invention may be created in a computer usable medium (such as a CD-ROM or other medium) having computer readable code embodied therein. The computer usable medium preferably contains a number of computer readable program code devices configured to cause a computer to affect the various functions required to carry out the invention, as herein described.

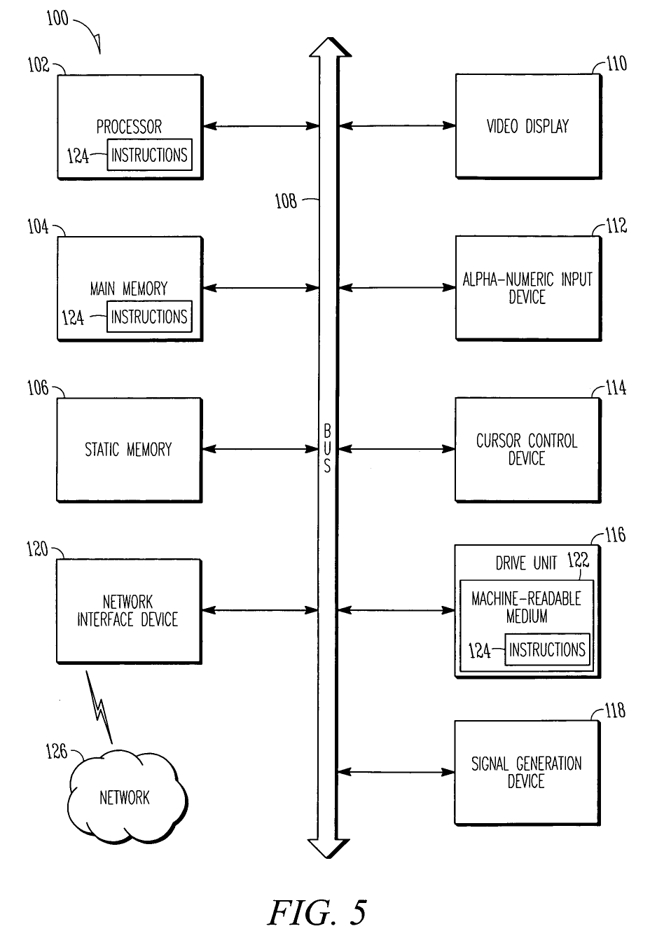

FIG. 5 shows a diagrammatic representation of machine in the exemplary form of a computer system 100 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 100 includes a processor 102 (e.g., a central processing unit (CPU), a graphics processing unit (GPU) or DSP), a main memory 104 and a static memory 106, which communicate with each other via a bus 108. The computer system 100 may further include a video display unit 110 (e.g., a liquid crystal display (LCD) or a cathode ray tube (CRT)). The computer system 100 also includes an alphanumeric input device 112 (e.g., a keyboard), a user interface (UI) navigation device 114 (e.g., a mouse), a disk drive unit 116, a signal generation device 118 (e.g., a speaker) and a network interface device 120.

The disk drive unit 116 includes a machine-readable medium 122 on which is stored one or more sets of instructions and data structures (e.g., software 124) embodying or utilized by any one or more of the methodologies or functions described herein. The software 124 may also reside, completely or at least partially, within the main memory 104 and/or within the processor 102 during execution thereof by the computer system 100, the main memory 104 and the processor 102 also constituting machine-readable media.

The software 124 may further be transmitted or received over a network 126 via the network interface device 120 utilizing any one of a number of well-known transfer protocols (e.g., HTTP).

While the machine-readable medium 122 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

While the methods disclosed herein have been described and shown with reference to particular operations performed in a particular order, it will be understood that these operations may be combined, sub-divided, or re-ordered to form equivalent methods without departing from the teachings of the present application. Accordingly, unless specifically indicated herein, the order and grouping of the operations is not a limitation of the present application.

It should be appreciated that reference throughout this specification to “one embodiment” or “an embodiment” or “one example” or “an example” means that a particular feature, structure or characteristic described in connection with the embodiment may be included, if desired, in at least one embodiment of the present invention. Therefore, it should be appreciated that two or more references to “an embodiment” or “one embodiment” or “an alternative embodiment” or “one example” or “an example” in various portions of this specification are not necessarily all referring to the same embodiment. Furthermore, the particular features, structures or characteristics may be combined as desired in one or more embodiments of the invention.

It should be appreciated that in the foregoing description of exemplary embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed inventions require more features than are expressly recited in each claim. Rather, as the following claims reflect, inventive aspects lie in less than all features of a single foregoing disclosed embodiment, and each embodiment described herein may contain more than one inventive feature.

While the invention has been particularly shown and described with reference to embodiments thereof, it will be understood by those skilled in the art that various other changes in the form and details may be made without departing from the spirit and scope of the invention.

What is claimed is:

1. A method for collecting log data from one or more components distributed in the network, the method comprising:
receiving a report of an error and log data related to the error from a first component of said one or more components of the network; and
in response to said report, requesting, from the other of said one or more components, log data related to the error, wherein the requesting includes specifying an event key related to the error.

2. The method of claim 1, wherein the one or more components include one or more Voice-over-IP telephones.

3. The method of claim 1, wherein the log data is indexed with one or more event keys.

4. The method of claim 1, wherein the requesting operation includes specifying an event key related to the error.

5. The method of claim 1, wherein the server receives a selected portion of the log data.

6. The method of claim 1, further comprising:
providing a communication interface from the server to third parties, said interface for reporting alarm conditions.

7. The method of claim 6, further comprising:
reporting the alarm conditions based on the error.

8. The method of claim 1, which comprises storing the log data related to the error in a persistent storage device.

9. A machine-readable medium embodying instructions which, when executed by a machine, cause the machine to perform the method of claim 1.

10. In a component attached to a network having a server and other components connected thereto, a method for collecting and reporting log data to the server, the method comprising:
registering with the server;
collecting log data at the component and indexing the log data using one or more event keys; and
reporting to the server an error from the component, wherein the reporting operation reports log data related to the error and reports an event key.

11. The method of claim 10, wherein the collecting operation utilizes a circular buffer.

12. The method of claim 10, wherein the collecting operation compresses the log data.

13. The method of claim 10, wherein the component includes one or more Voice-over-IP telephones.

14. The method of claim 10, wherein the colleting includes indexing the log data with one or more event keys.

15. The method of claim 10, wherein the reporting specifies an event key related to the error.

16. A machine-readable medium embodying instructions which, when executed by a machine, cause the machine to perform the method of claim 10.

17. A system to collect log data from one or more components distributed in the network, the system comprising:
means for receiving a report of an error and log data related to the error from a first component of said one or more components of the network; and
means for requesting, from the other of said one or more components and in response to said report, log data related to the error, wherein the requesting includes specifying an event key related to the error.

18. A component for collecting and reporting log data to the server, the component comprising:
means for registering with a server in a network;
means for collecting log data at the component and indexing the log data using one or more event keys; and
means for reporting to the server an error from the component, wherein the reporting operation reports log data related to the error and reports an event key.
